(19) United States
(12) Patent Application Publication
(10) Pub. No.: US 2007/0103543 A1
(43) Pub. Date: May 10, 2007

(54) Network panoramic camera system

(75) Inventors: Geoffrey T. Anderson, Cornwall On Hudson, NY (US); Adrian Parvulescu, River Vale, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Polar Industries, Inc., New Windsor, NY (US)

(21) Appl. No.: 11/500,000

(22) Filed: Aug. 7, 2006

Related U.S. Application Data
(60) Provisional application No. 60/706,363, filed on Aug. 8, 2005.

(51) Int. Cl. H04N 7/00

(52) U.S. Cl. 348/36

(57) ABSTRACT

The present invention provides a 360 degree panoramic IP network camera system. Analog panoramic data is obtained by an imaging subsystem, which is then digitized, processed, encoded, and streamed by a control subsystem in accordance with user input through a graphical user interface. Access to and control of the imaging data may be provided through a web server. The web server enables users across a network to access the imaging data via a web browser-based user interface. Different types and configurations of panoramic images may be generated, processed, stored and displayed for use in a wide variety of application. A video analyzer may also be employed for post processing of data to direct image capture and other information gathering.

### CROSS REFERENCE TO RELATED APPLICATION

This application claims the benefit of the filing date of U.S. Provisional Patent Application No. 60/706,363 filed Aug. 8, 2005 and entitled “Network Panoramic Camera System,” the entire disclosure of which is hereby incorporated by reference herein.

### BACKGROUND OF THE INVENTION

The present invention relates generally to network information recording systems. More particularly, the present invention relates to network video recording systems and methods for use with panoramic or wraparound imaging devices.

In the past, imaging devices have been used as an integral part of network-based cameras systems ranging from security applications to videoconferencing to image transfer over the Internet or “webcasting.” Early imaging devices provided low resolution, black and white still image. Over time, the sophistication and capabilities of imaging devices has greatly increased.

For example, while panoramic cameras have been around for a long time, it has only been recently that electronic panoramic-type cameras have been adapted for use in network camera systems. However, true 360 degree panoramic (“full panoramic”) images are not easy to generate. Typically, multiple frames or shots have to be “stitched” together in order to achieve a full panoramic scene. Connecting the shots together can often result in discontinuities in the image that detract from the overall visual effect.

Some systems have attempted to record a single panoramic image by rotating the lens during image capture. However, it is difficult to steadily rotate the image sensor without introducing jitter or other distortion effects. In addition, the rotation is not performed instantaneously, but rather takes places over time, which can be problematic for live-action or other time sensitive scenes.

Recently, panoramic or fisheye cameras have been developed that can capture a 360° image in a full circle toroidal or donut-type format. See, for instance, U.S. Pat. No. 6,459,451 (“the '451 patent”), entitled “Method and Apparatus for a Panoramic Camera to Capture a 360 Degree Image,” which issued on Oct. 1, 2002, the entire disclosure of which is hereby incorporated by reference herein.

Most recently, Sony Corporation (“Sony”) has introduced panoramic camera modules that can be used in a variety of applications, such as security, videoconferencing, webcasting, and remote recording. Basic information on Sony's 360° camera modules may be found in a variety of articles. One such article is “Camera Module Adopts Full-Circle 360° Lens to Open New Markets,” the entire disclosure of which is hereby incorporated by reference herein. This article discusses a camera module with a full-circle lens that employs a 380 K-pixel, 30 frame/sec CCD that outputs a ring-shaped image as a composite video signal. The article also discusses a high resolution camera having a 1.28 megapixel, 7.5 frame/sec CCD for panoramic imaging. Sony's camera modules come in different types, including a desktop model and a ceiling mount model. Details of Sony's RPU-C2512 desktop model are provided in “RPU-C2512 (Desktop Model) NEW!!!,” the entire disclosure of which is hereby incorporated by reference herein. Details of Sony's RPU-C251 desktop model and RPU-C352 are provided in “Sony Global—360-degree Camera” and in “Panoramic Camera Modules,” respectively, the entire disclosures of which are hereby incorporated by reference herein. Additional details of the RPU-C-2512 and the ceiling mountable RPU-C3522 are provided in “360° vision. Limitless possibilities,” the entire disclosure of which is hereby incorporated by reference herein.

As explained in the aforementioned articles, a full-circle lens reflects and passes image signals through a relay lens to a CCD imager. The resultant image formed on the CCD is a “ring” image. The ring image can be processed using a signal processor to generate more conventional views, namely the “wide,” “half wide,” “quad,” “quad & wide,” and “wide & zoom” images. However, while these camera modules create RGB images in NTSC and PAL formats, the outputs are analog and are not designed for network use. The viewing of the panoramic image is available using a personal computer with specialized software.

It is thus desirable to provide a flexible system that can be used with panoramic camera modules to provide advanced processing to fully exploit the benefits of panoramic imaging over a network system.

### SUMMARY OF THE INVENTION

The present invention provides a network-based panoramic camera system that provides access to panoramic images and other audiovisual data in a true digital format. The system includes an imaging subsystem providing analog 360° images, a control subsystem for digitally processing and encoding the analog images, and a web server-based user interface for accessing the data from anywhere on the network. The system preferably operates on an IP-compatible network, such as via the Internet or an intranet. The digital audiovisual data can be stored locally on the control subsystem or streamed over the network. Commands are provided which manipulate the 360° images and signaling data identifies events detected by the network-based panoramic camera system

In a preferred embodiment, the present invention provides a 360 degree panoramic IP network camera system. Analog panoramic data is obtained by an imaging subsystem, which is then encoded and processed by a control subsystem. Access to and control of the imaging data is provided through a web server and associated user interface. The web server enables users across a network to access the imaging data via a web browser-based user interface. The IP network camera system is desirably a fully integrated system, incorporating the imaging subsystem, the control subsystem and the user interface together as a unit in a single housing. The housing can be placed by a user in his or her office, in a house, a manufacturing facility or other structure. The housing may also be located within a car, bus, train, airplane, ship or other vehicle. Once the housing has been installed, the system may be hooked up to a network using, for example, a CAT5 or other network cable. The network cable desirably provides power to the system components, in addition to enabling users to access the system remotely.

The network panoramic camera system for use in managing 360 degree panoramic images on a network preferably comprises a panoramic imaging subsystem, a sensory device, a control subsystem and a user interface. The panoramic imaging subsystem is operable to create analog full panoramic imaging data. The sensory device is remote from the imaging subsystem and is operable to sense a condition associated with the network panoramic camera system. The control subsystem includes a digital encoder operatively connected to receive input analog imaging data transmitted from the imaging subsystem and to generate digitally encoded A/V data, a power subsystem operable to receive input power from a network connection and to power the control subsystem and the imaging subsystem therefrom, and a processor operable to process the digitally encoded A/V data and input sensory data from the sensory device to create processed digital data. The user interface is a web-server based user interface operatively connected to the imaging subsystem and the sensory device. The user interface is operable to receive commands from an authorized user on the network and to present the processed digital data to the authorized user.

In accordance with an embodiment of the present invention, a panoramic camera system for use in processing full panoramic images is provided. The system comprises a panoramic imaging subsystem, a control subsystem, and a web-server based user interface. The panoramic imaging subsystem is operable to capture a full panoramic image and to create panoramic image data therefrom. The control subsystem is operable to generate digital data from the panoramic image data. The control subsystem includes a processor operable to receive the panoramic image data and to create processed digital image data therefrom, and a digital encoder in operative communication with the processor for generating encoded visual data. The web-server based user interface is in operative communication with the panoramic imaging subsystem and the control subsystem. The user interface is operable to receive commands from an authorized user, to direct operation of the panoramic imaging subsystem and the control subsystem based on the received commands, and to display the digital data to the authorized user in a predetermined format.

In one alternative, the system further comprises a sensory device in operative communication with the control subsystem and the user interface. The sensory device is operable to sense a condition associated with the panoramic camera system. The processor is further operable to process input sensory data from the sensory device and incorporate the processed sensory data with the processed digital imaging data to generate the digital data therefrom.

In this case, the user interface is preferably further operatively connected to the sensory device. The user interface enables the authorized user to select imaging parameters to manage operation of the panoramic imaging subsystem, to select control parameters to manage operation of the control subsystem, and to select sensory parameters to manage operation of the sensory device. Preferably, the user interface is further operable to select one or more view types based upon the panoramic imaging data to present displayed data to the authorized user in the predetermined format. The view types may include different visual formats, image capture parameters, etc. For instance, the view types desirably include at least one of ring, wide, half wide, dual half wide, dual half wide mirror, quad, quad and wide, quad and zoom, and wide and zoom visual formats.

In another alternative, the control subsystem generates processed digital data by digitizing, packetizing and streaming the panoramic imaging data and the sensory data together. In a further alternative, the predetermined format does not require processing in order to display the display data.

In yet another alternative, the panoramic imaging subsystem includes a plurality of full panoramic imaging devices. The control subsystem is operable to receive and process the panoramic imaging data from each imaging device together. In this case, each of the imaging devices is preferably managed by the user interface. If the system senses an environmental condition associated with the system, at least one of the imaging devices preferably generates selected imaging data in response thereto. Desirably, selected parameters of each of the imaging devices are controlled independently through the user interface.

In another alternative, the control subsystem further comprises a networking subsystem operable to provide data communication with and a power supply to the panoramic imaging subsystem. Here, the networking subsystem preferably provides an Ethernet connection to the panoramic imaging subsystem for the data communication. In this case, power is supplied over the Ethernet connection.

In a further alternative, the system further comprises a video analyzer operatively connected to the panoramic imaging subsystem and the control subsystem. The video analyzer is operable to analyze the digital data to identify at least one of a visual characteristic and a sensory characteristic. It is also operable to direct at least one of the panoramic imaging subsystem and the control subsystem to utilize a selected parameter in response to at least one of the visual and the sensory characteristic. Thus, the video analyzer may post process captured data, and may direct operation of various system components in response to the post processing. For instance, the video analyzer may control the captured video format, e.g., directing the imager to zoom in on a particular area of interest, or it may trigger multiple imagers and/or sensors to capture data that can be combined into a single comprehensive package. Thus, the system may capture one or more video streams coupled with audio and motion detection data to provide an alarm indication to an authorized user.

In accordance with another embodiment of the present invention, a panoramic image processing method is provided. The method comprises generating full panoramic imaging data with a full panoramic imager; creating panoramic image data from the full panoramic imaging data; generating sensory device data based upon an environmental condition; processing the panoramic image data and the sensory device data; and generating display data based upon the processed panoramic image data and sensory device data.

In one alternative, the method further comprises authenticating a user; and presenting the display data to the user after authentication.

In another alternative, the panoramic imaging data is integrated with the sensory data during processing. Here, the integrated data is packetized according to a predetermined format. The sensory data may be audio data associated with the full panoramic imaging data.

In a further alternative, the method further comprises powering the full panoramic imager over an Ethernet connection. In yet another alternative, if the environmental condition is an alarm condition, the panoramic image data is created according to a pre-selected format.

In another alternative, the method further comprises analyzing the processed panoramic image data and the sensory device data to identify at least one of a visual characteristic and a sensory characteristic; and utilizing a selected parameter in response to the visual or sensory characteristic to vary at least one of the panoramic image data and the sensory device data.

In accordance with yet another embodiment of the present invention, a panoramic image processing apparatus is provided. The apparatus comprises means for receiving panoramic imaging data from a full panoramic imaging device; means for processing the received panoramic imaging data to create processed digital imaging data therefrom; means for encoding the processed digital imaging data; means for presenting the encoded and processed digital imaging data to a user of the apparatus; and user interface means for receiving user input and for controlling operation of the processing means, the encoding means and the presenting means.

In one alternative, the processing means is operable to receive sensory data from a sensory device and to process the panoramic imaging data and the sensory data together. In another alternative, processing the panoramic imaging data and the sensory data together includes digitizing and packetizing the panoramic imaging data and the sensory data.

In a further alternative, the means for receiving panoramic imaging data is operable to receive the panoramic imaging data from a plurality of networked imaging devices. In this case, the apparatus further comprising means for receiving sensory data from a plurality of networked sensory devices. The processing means is further operable to multiplex the panoramic imaging data and the sensory data together. The presenting means is further operable to generate display data for presentation to the user in a predetermined format including at least some of the multiplexed panoramic imaging data and the sensory data. In this alternative, the apparatus may further comprise a video analyzer operable to analyze the multiplexed panoramic imaging data and the sensory data to identify at least one of a visual characteristic and a sensory characteristic. The video analyzer is also operable to direct at least one of capture and processing of the panoramic imaging data in response to the identified characteristic. For instance, the video analyzer may request that an imager zoom in on an area of interest, may request that different views such as a ring or a dual half wide mirror are obtained.

### BRIEF DESCRIPTION OF THE DRAWINGS

FIG. 1 illustrates a network panoramic camera system in accordance with one embodiment of the present invention.

FIG. 2 further illustrates the network panoramic camera system of FIG. 1.

FIGS. 3(a)-(f) illustrate examples of raw and processed panoramic images that can be obtained in accordance with the present invention.

FIG. 4 illustrates a schematic diagram of a power supply subsystem in accordance with a preferred embodiment of the present invention.

FIGS. 5(a)-(b) illustrate imaging subsystems in accordance with preferred embodiments of the present invention. 5(c) illustrates an integrated network panoramic camera system in accordance with aspects of the present invention.

FIGS. 6(a)-(c) illustrate views of an integrated network panoramic camera system having an imaging subsystem, a control subsystem including sensory I/O and a user interface in accordance with a preferred embodiment of the present invention.

FIG. 7 illustrates external connections for an integrated network panoramic camera system in accordance with aspects of the present invention.

FIG. 8 is a flow diagram of system operation steps performed in accordance with a preferred embodiment of the present invention.

FIG. 9 is a flow diagram of steps performed in conjunction with a user interface in accordance with a preferred embodiment of the present invention.

FIGS. 10(a)-(d) present exemplary graphical user interface pages in accordance with aspects of the present invention.

FIGS. 11(a)-(b) present additional exemplary graphical user interface pages in accordance with aspect of the present invention.

### DETAILED DESCRIPTION

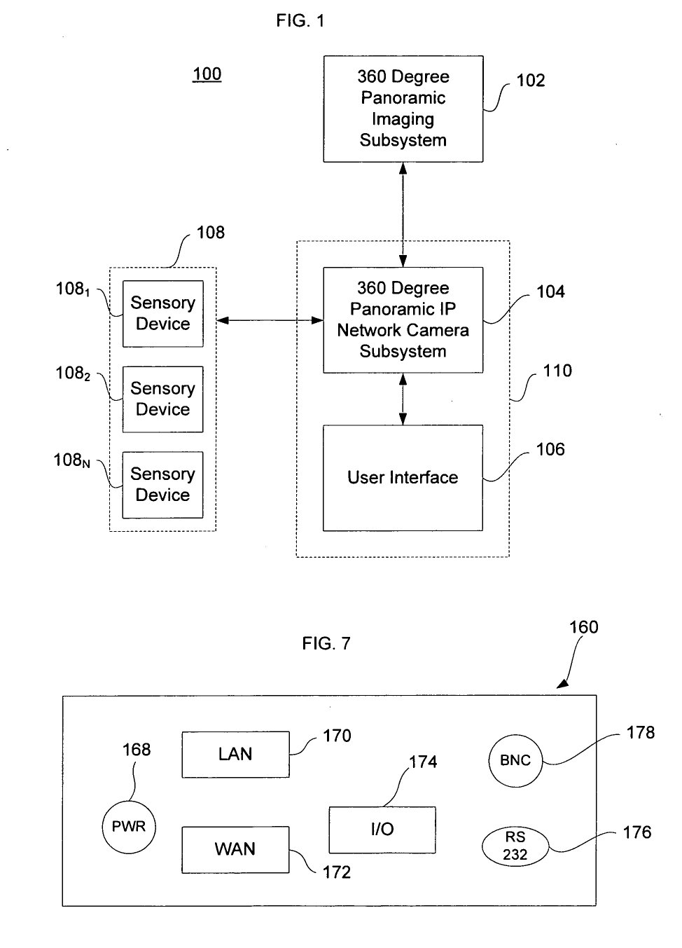

FIG. 1 illustrates a block diagram of a network panoramic camera system 100 in accordance with a preferred embodiment of the present invention. As shown in this figure, the system 100 includes a 360° imaging subsystem 102, a control subsystem 104 and a user interface 106. One or more sensory devices 108 for sensing environmental conditions may also be connected to the system 100. Desirably, each of these components is capable of generating digital output signals. While only three sensory devices 108 are shown connected in this figure, any number of sensory devices 108₁ . . . 108_{N} can be provided. The imaging subsystem 102, the user interface 106, and the sensory devices 108 (if any) are all connected to the control subsystem 104, either directly or indirectly.

Preferably, the control subsystem 104 and the user interface 106 are incorporated as part of a subsystem 110 to share resources such as a microprocessor, memory and storage. Subsystem 110 can include, for example, one or more connectors, for connection to a display, which could include, for instance, a CRT, LCD, or plasma screen monitor, TV, projector, etc. Subsystem 110 may also include connectors for LAN/WAN, connectors for power AC/DC power input, etc.

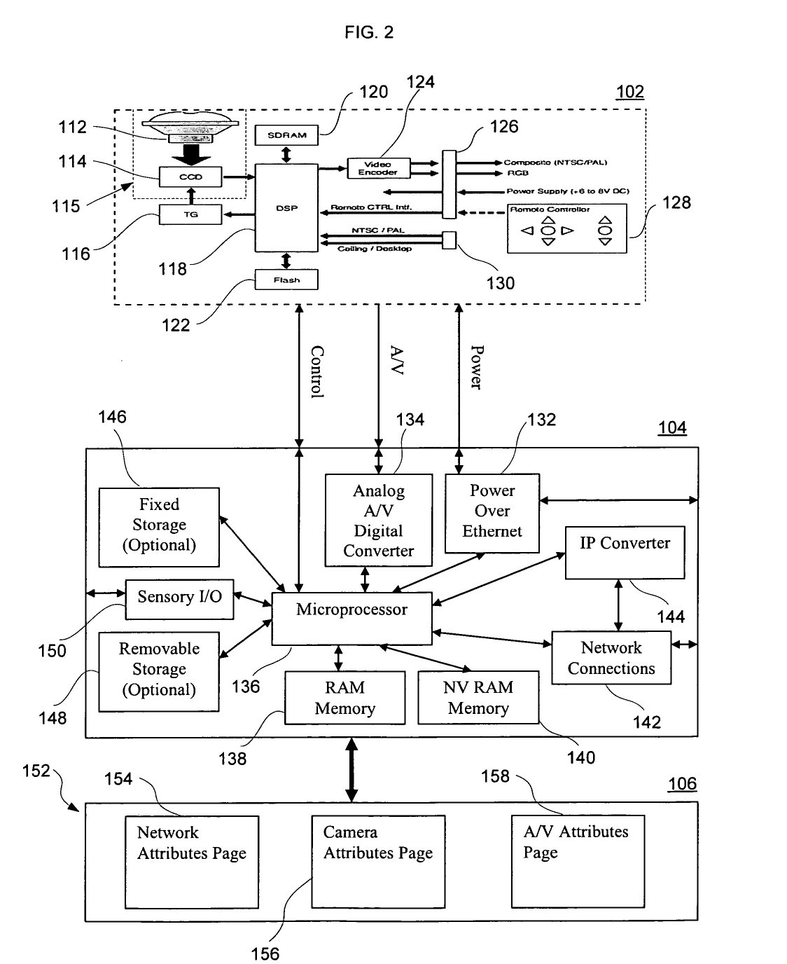

FIG. 2 illustrates a preferred embodiment of the network panoramic camera system 100 in more detail. The imaging subsystem 102 includes at least one 360° lens system 112 and at least one imager, for example a solid state imager such as charge coupled device (“CCD”) 114. The 360° lens system 112 and the CCD 114 may be provided as a unit 115. In a preferred embodiment, the 360° lens system 112 comprises a true 360 degree panoramic or fisheye lens described above from Sony or the '451 patent. Alternatively, 360° images may be formed using a combination of multiple lenses in the lens system 112. The imager 114 is preferably a CCD, although a CMOS imager may be employed. The CCD imager 114 may comprise an optical imager, a thermal imager or the like. The CCD 114 may be configured to have any given resolution depending upon system requirements, which include overall image quality, display size, cost, etc. Preferably, the CCD 114 is of sufficient resolution such that processed quad or half wide images are at least 640×480 pixels. More preferably, the CCD 114 has at least 0.5 megapixels. Most preferably, the CCD 114 has at least 1.0 megapixels, such as between 2.0 and 5.0 megapixels or more. Of course, it should be understood that the number of megapixels is expected to increase as advances in manufacturing techniques occur.

Timing signals are supplied to the CCD 114 by a timing generator 116. A processor such as digital signal processor (“DSP”) 118 controls the basic functions of the imaging subsystem 102, including the lens system 112, the CCD 114 and the timing generator 116. The DSP 118 performs dewarping of the 360° panoramic images. One or more memories may be associated with the DSP 118. As shown, an SDRAM 120 and a flash memory 122 are preferably associated with the DSP 118. It should be understood that other types of memories may be used in addition to or in place of these memories. The SDRAM 120 and the flash memory 122 are used to store, for example, program code and raw image data. The DSP 118, in conjunction with the SDRAM 120 and/or the flash memory 122, performs image processing to de-warp and stretch the raw 360° annular ring-shaped image to obtain other views. The DSP 118 may be part of the imaging subsystem 102, the control subsystem 104, or may be separate from the imaging and control subsystems while being logically connected thereto.

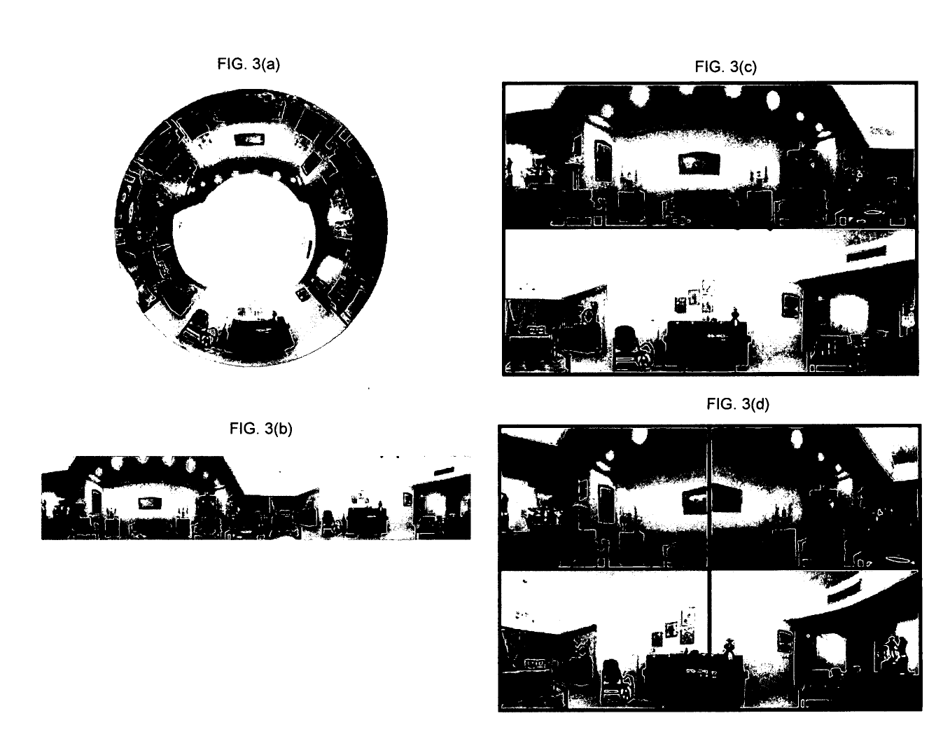

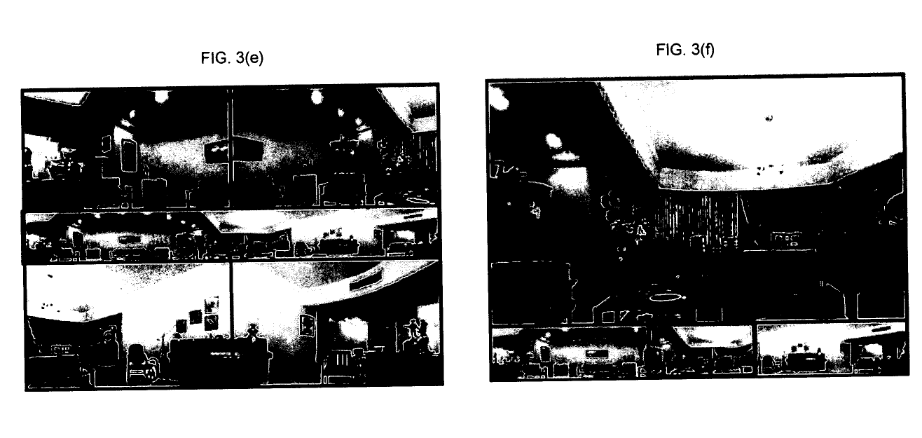

FIG. 3(a) illustrates an example of a raw 360° image, which is in “ring” format. In this format, the inner and outer rings of the image each have a predetermined radius. FIGS. 3(b)-(f) illustrate dewarped images, namely wide, half wide, quad, quad & wide, and wide & zoom images, respectively. It should be understood that other views and combinations of views may be achieved. For example, one or more thumbnail images may be presented alone or in combination with wide, half wide or zoom images.

Returning to FIG. 2, an analog video encoder 124 receives image data from the DSP 118 and outputs the raw or processed/dewarped images in analog format via connector 126. As shown here, the output may be in an RGB or composite video (e.g., NTSC or PAL) analog output. Images may be generated and/or. output as, for instance, still images, a burst mode of 3-10 frames per second, or as video images at 30 frames per second or more. Of course, any other suitable frame rate may be utilized. Audio data may also be captured by the imaging subsystem 102. In this case, the audio data can be processed and output by the DSP 118 as analog audio information.

The DSP 118 may receive input such as instructions or other data through the connector 126. For instance, instructions may be input by a remote controller or other input 128. The DSP 118 may also receive input from connector 130. Preferably, control signals such as commands or instructions are supplied by the control subsystem 104. The control subsystem 104 preferably also supplies power to the imaging subsystem 102. Control signals supplied to the DSP 118 include, by way of example only, pan, tilt and/or zoom instructions that the DSP 118 will perform on the analog image signals. The control signals may require that the imaging subsystem 102 select a specific view, such as a quad and wide view. The commands/instructions may be automated commands that are triggered at a given time or based upon a predetermined event. Alternatively, the commands/instructions may be manually entered by a user, for example a user logged onto a web server in user interface 106 or elsewhere.

The imaging subsystem 102 outputs the analog audio and/or video (“A/V”) data to the control subsystem 104 for further processing. The control subsystem 104 may also receive signaling or control information from the imaging subsystem. By way of example only, the signaling information may be utilized in conjunction with one or more of the sensory input devices 108 to handle motion detection, sound generation, user authentication, alarm events, etc.

The control subsystem 104 may perform various functions either autonomously or in response to the commands/instructions. For instance, the control subsystem 104 may increase or decrease its transmitted frame rate of still or full motion images. The resolution may be increased or decreased, for example based on detected motion or suspicious activity. The imaging subsystem 102 may also send the analog A/V information as well as signaling information such as motion detection or no motion detection to the control subsystem 104 so that other actions such as automated alerts can be activated. The imaging subsystem 102 does not include a display device. However, the analog video information to the control subsystem 102 may be output in an NTSC format, namely RS170A. Automated alerts established by 104 and preferably stored in NV RAM 140 can send a message or signal over the network to provide unattended security functions. As discussed above, the imaging subsystem 102 receives commands, either manual or automatic, from the control subsystem 104 and, based on the commands, can perform functions such as selecting one or multiple views, zoom, pan, and/or tilt within the 360° image, follow a preset tour, detection motion in a field of view, etc.

The sensory I/O devices 108 (see FIG. 1), if used, can supplement the A/V information provided by the imaging subsystem 102 and may be used to perform unattended security functions such as automated alerts as established in 104 through User Interface functions on attributes tables 154-158. By way of example only, the sensory devices 108 can perform typical sensor functions such as motion detection, sound detection, smoke detection, carbon monoxide detection, temperature sensing, pressure sensing or altitude determination. Other sensor functions may include, but are not limited, to sensing radioactivity levels or ascertaining the presence or absence of biological or chemical substances. Metal detection is yet another example of what selected sensory devices 108 may perform. Typical examples of output functions would be turn on lighting or alarm systems.

One or more of the sensory devices 108 may provide data directly to the imaging subsystem 102 instead of transmitting information directly to the control subsystem 104. For instance, one of the sensory devices 108 may provide audio information to an imaging subsystem 102 that is not audio capable. In this case, the imaging subsystem 102 may be configured to transmit both the audio and visual information to the control subsystem 104 for processing. Alternatively, one of the sensory devices 108 may perform motion detection. In this case, upon sensing motion, the sensory device 108 may send a signal to the imaging subsystem 102, which in turn may send still or video images back to the control subsystem 104.

Each of the sensory I/O devices 108 may perform a specific function, or may perform multiple functions. By way of example only, a selected sensory device 108 may be placed in a bathroom and perform smoke detection and motion sensing. If smoke is detected without also triggering the motion sensor, indicating the possibility of an electrical fire, the selected sensory device 108 may send an alarm to the control subsystem 104 as well as cause the imaging subsystem 102 in the bathroom to turn on. However, if smoke is detected along with motion in the bathroom, indicating the presence of a person smoking, the selected sensory device 108 may only send an alarm to the control subsystem 104 to alert a responsible party such as security personnel to take appropriate action. A typical example of an output function that can be triggered by sensory input would be to have the lights in a room turned on when motion sensory input is triggered.

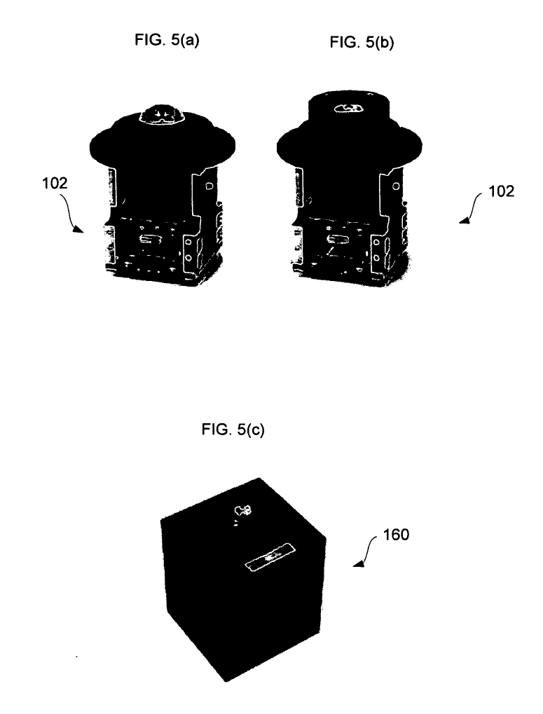

The control subsystem 104 may connect to the imaging subsystem 102 via a wired link, a wireless link or both. Preferably, the control subsystem 104 connects to the imaging subsystem 102 with a wired connection such as a parallel ribbon cable, fiber optic, Ethernet or CAT 5 cable. A preferred example of the control subsystem 104 is shown in detail in FIG. 2, which may be enclosed in a housing (see FIG. 5(c) below) along with the imaging subsystem 102 and external connectors (described in FIG. 7 below).

The control subsystem 104 may include a power block 132 providing,. for example, “Power Over Ethernet.” The power block 132 is used to supply power to the imaging subsystem 102 through the Ethernet or other connection. Most preferably, the power block 132 conforms to IEEE standard 802.3af, the entire disclosure of which is hereby incorporated by reference herein. Benefits and features of the 802.3af standard may be found in “IEEE802.3af Power Over Ethernet: A Radical New Technology,” from www.PowerOverEthernet.com, the entire disclosure of which is hereby incorporated by reference herein.

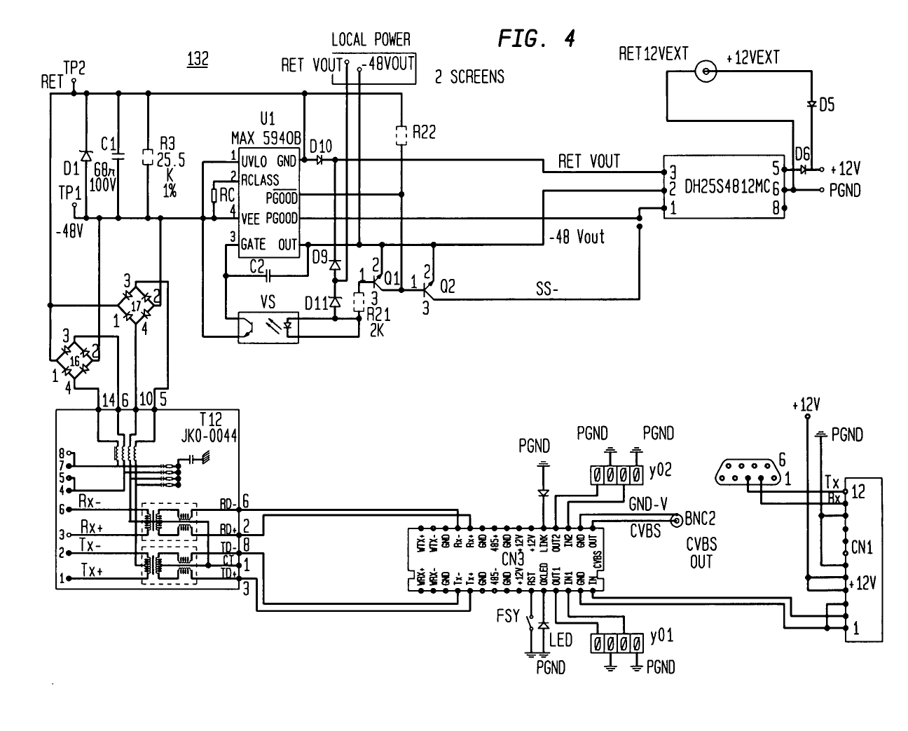

FIG. 4 illustrates a preferred embodiment of power block 132. The power block 132 may receive an external power signal of, for instance, 12 volts, and may supply power to both the control subsystem 104 as well as the imaging subsystem 102. In this way, the imaging subsystem 102 and the control subsystem 104 will always be operational unless power is disconnected. Thus, it is desirable to include a redundant power supply that ensure the power block 132 can continuously provide power to the imaging subsystem 102 and the control subsystem 104.

Returning to FIG. 2, the control subsystem 104 also preferably includes an A/D converter 134, a microprocessor or other controller 136, memory such as RAM 138 and nonvolatile RAM 140, as well as a network link 142, which may connect to one or more networks. An IP converter 144 may be utilized alone or in combination with the network link 142 to generate data packets in, for example, TCP/IP format. The control subsystem 104 may also include optional storage devices such as fixed storage unit 146 and/or removable storage unit 148. Sensory I/O unit 150 may also be provided for communication with the sensory devices 108.

The A/D converter 134 receives analog image and/or audio data from the imaging subsystem 102 and builds a digital A/V stream. Preferably, the A/D encoder converts the analog information from the imaging subsystem 102 into digital data which is then encoded by the controller 136. The controller 136 may directly perform the encoding, or the encoding may be performed by a separate DSP, ASIC or other device. More preferably, the encoding is in accordance with an MPEG format such as MPEG 4. Alternatively, other encoding formats such as JPEG for still images or MP3, WAVE or AIFF for audio. The encoded digital A/V stream may be stored locally by the control subsystem 104, for example in the RAM 138, the fixed storage 146, and/or in the removable storage 148. Alternatively, the encoded digital A/V stream may be transmitted to a remote storage device or external processor or computer via the network link 142 and the IP converter 144.

Preferably, the controller 136 outputs commands or instructions to the imaging subsystem 102 to, for instance, select one or more views, electronically pan, tilt and/or zoom within the raw 360° image or change/manage the overall functions of the imaging subsystem 102. Such commands or instructions may change the image(s) or the image formats presented to the user interface 106.

In general, the controller 136 is the overall manager of the network panoramic camera system 100. The controller 136 manages communications with the other devices in the system such as the imaging subsystem 102, the user interface 106, and the sensory devices 108. The controller 136 also manages communication with other networked devices or systems as will be discussed in more detail below.

When the controller 136 receives imaging and/or audio data from the imaging subsystem 102, or when it receives other information from the sensory inputs 108, the controller 136 performs data processing on the received information. In one example, the A/V information from the imaging subsystem 102 may be combined into a single stream at the controller 136 and processed together for local storage or transmission over the network, preferably in accordance with the IP protocol.

The controller 136 is capable of responding to and reacting to sensory input and A/V information received from the sensory devices 108 and the imaging subsystem 102. By way of example only, the controller 136 may perform compression or decompression of the video or audio information beyond the MPEG4 or other encoding. The processing by the controller 136 may also include object detection, facial recognition, audio recognition, object counting, object shape recognition, object tracking, motion or lack of motion detection, and/or abandoned item detection. In another example, the controller 136 may initiate communications with other components within the system 100 and/or with networked devices when certain activity is detected and send tagged A/V data for further processing over the network. The controller 136 may also control the opening and closing of communications channels or ports with various networked devices, perform system recovery after a power outage, etc.

While shown as a single component, the controller 136 may comprise multiple integrated circuits that are part of one or more computer chips. The controller 136 may include multiple processors and/or sub-processors operating separately or together, for example, in parallel. By was of example only, the controller 136 may include one or more Intel Pentium 4 and/or Intel Xeon processors. ASICs and/or DSPs may also be part of the controller 136, either as integral or separate components, which, as indicated above, may perform encoding. One or more direct memory access controllers may be used to communicate with RAM 138, NV RAM 140, fixed storage device 146, and/or the removable storage device 148.

The RAM 138 preferably provides an electronic workspace for the controller 136 to manipulate and manage video, audio and/or other information received from the imaging subsystem 102 and the sensory devices 108. The RAM 138 preferably includes at least 128 megabytes of memory, although more memory (e.g., one gigabyte) or less memory (e.g., 25 megabytes) can be used.

The fixed and removable storage devices 146, 148 may be used to store the operating system of the controller 136, operational programs, applets, subroutines etc., for use by the controller 136. The operating system may be a conventional operating system such as Windows XP or Linux, or a special purpose operating system. Programs or applications such as digital signal processing packages, security software, etc. may be stored on the fixed and/or removable storage devices 146, 148. Examples of signal processing software and security software include object detection, shape recognition, facial recognition and the like, sound recognition, object counting, and activity detection, such as motion detecting or tracking, or abandoned item detection. The fixed storage device 146 preferably comprises a non-volatile electronic or digital memory. More preferably, the digital memory of the fixed storage device 146 is a flash or other solid state memory.

The removable storage device 148 is preferably used to store database information, audio/video information, signaling data and other information. Raw or processed data received from the imaging subsystem 102, encoded data from the controller 136, and/or the sensory devices 108 is preferably stored in the removable storage device 148. In addition, imaging and sensory information processed by the controller 136 may also be stored in the removable storage device 148. The removable storage device 148 preferably includes at least 100 gigabytes of storage space, although more or less storage may be provided depending upon system parameters, such as whether multiple imaging subsystems 102 are employed and whether full motion video is continuously recorded. The removable storage device 148 preferably comprises a hard drive or a non-volatile electronic or digital memory. Removable storage provides the ability to offload collected data for review and safekeeping. A mirror image of the data on the removable storage device 148 may be maintained on the fixed storage 146 until recording space is exceeded. In this case, the data may be overwritten in a FIFO (first in first out) queuing procedure. More preferably, the digital memory of the removable storage device 148 is a hard drive, flash memory or other solid state memory. A backup of some or all of the imaging/sensory information may be stored in mirror fashion on the fixed and removable storage devices 146 and 148.

As explained above, the control subsystem 104 contains an operating system and operational software to manage all aspects of the network panoramic camera system 100. This includes, but is not limited to storing or transmitting A/V information from the imaging subsystem 102 and sensory data from the sensory devices 108; automated, UI signal or external signal response and reaction to sensory input; responding and reacting to processed A/V information, opening and closing external links, system recover after power outages, etc.

The links to the sensory devices 108, the imaging subsystem 102 and/or other networked devices may be wired or wireless. The connections may be serial or parallel. The connections may also operate using standard protocols such as IEEE 802.11, universal serial bus (USB), Ethernet, IEEE 1394 Firewire, etc., or non-standard communications protocols. Preferably, data is transmitted between system components using data packets such as IP packets.

The user interface 106 may be any form of user interface. Preferably, the user interface 106 is implemented in association with a web server. The web server permits access to the network panoramic camera system to modify settings which, by way of example only, may be stored in the NV RAM 140. New features or upgrades may be loaded, for example, by an FTP transfer. The web server also enables authorized users to send commands to the imaging subsystem 102. The web server may provide a graphical interface capable of full motion video along with audio output. More preferably, the web server provides a GUI in a web browser format. By way of example only, the NV RAM 140 may be configured to hold certain factory default settings for configuration for easy manual reconfiguration.

The user interface 106 preferably provides access to the network panoramic camera system 100, including the control subsystem 104 and the imaging subsystem 102. Most preferably, the web server, including the user interface 106, functions as the access point to the network panoramic camera system 100, providing IP-based network access to the A/V data in encoded digital format. For example, through the user interface 106, an authorized user can access the attribute settings for customization of the network panoramic camera system 100 to reside at a specific IP address. The web server, through the user interface 106, also preferably provides functions such as a command to start streaming A/V encoded digital data over the network and may be used to display responses. In a preferred embodiment, the present invention is controlled by a web server-based user interface as described in the “zPan100 User's Manual,” and accompanying “User Guide,” both documents © 2005 by Polar Industries, Inc., the entire disclosures of which are hereby incorporated by reference herein.

As seen in FIG. 2, GUI 152 of the user interface may include a network attributes page 154, a camera attributes page 156, and/or an A/V attributes page 158. These and other pages may be presented simultaneously on a display, or may be provided as linked or separate pages accessible with the web browser.

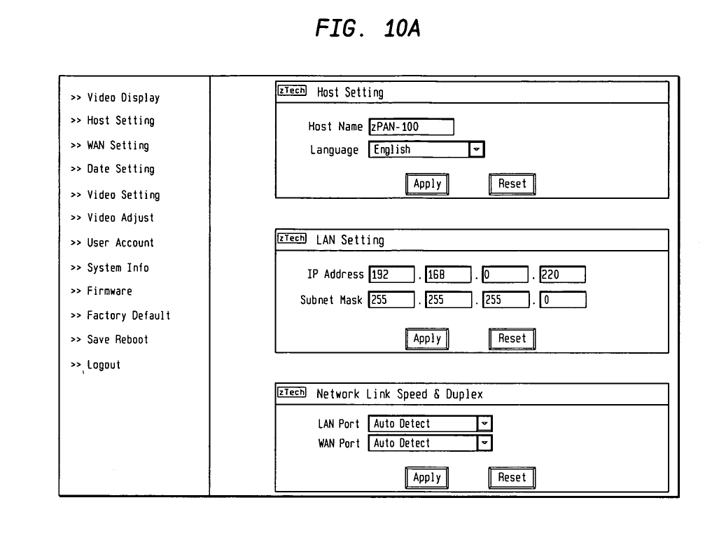

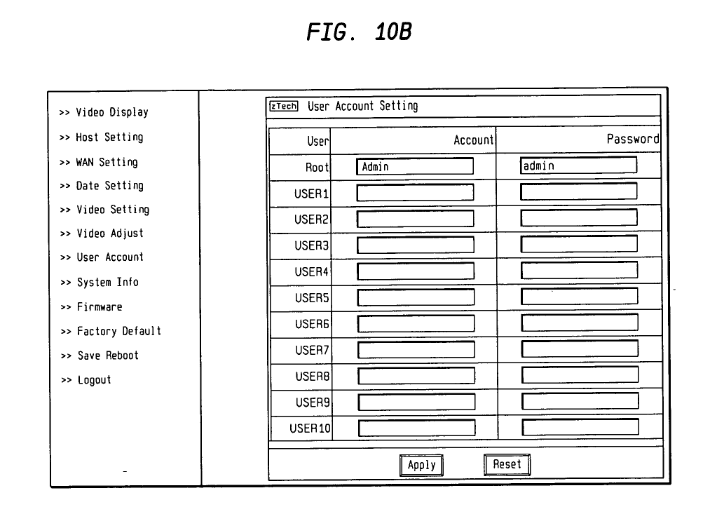

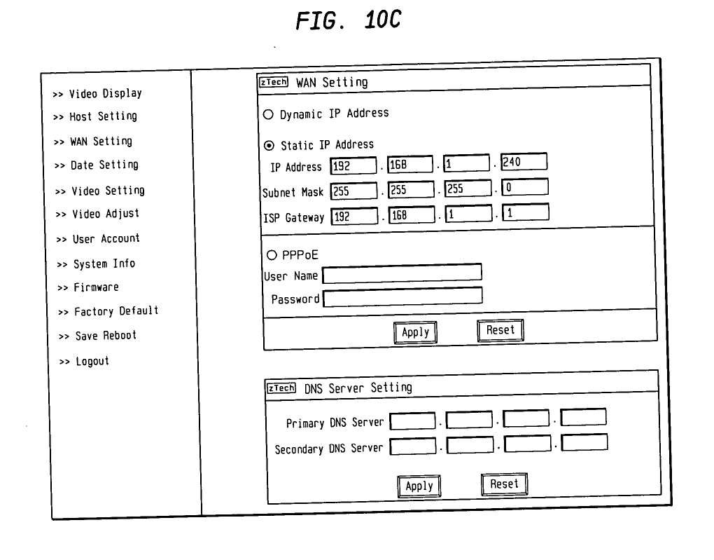

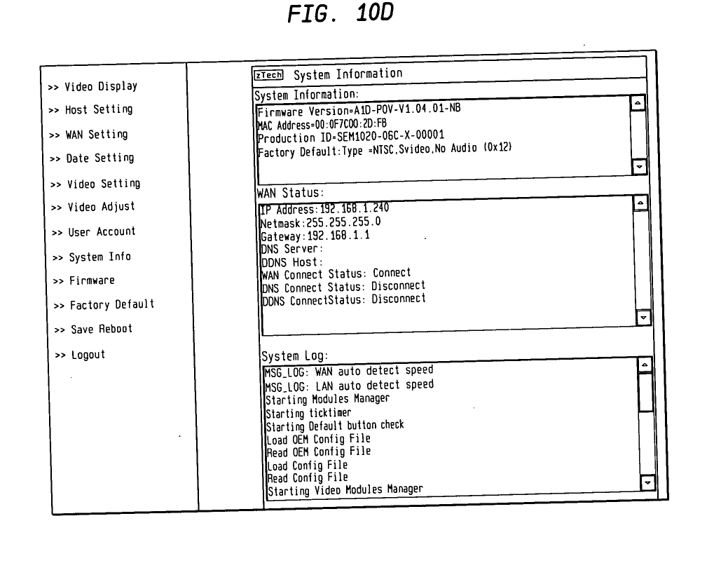

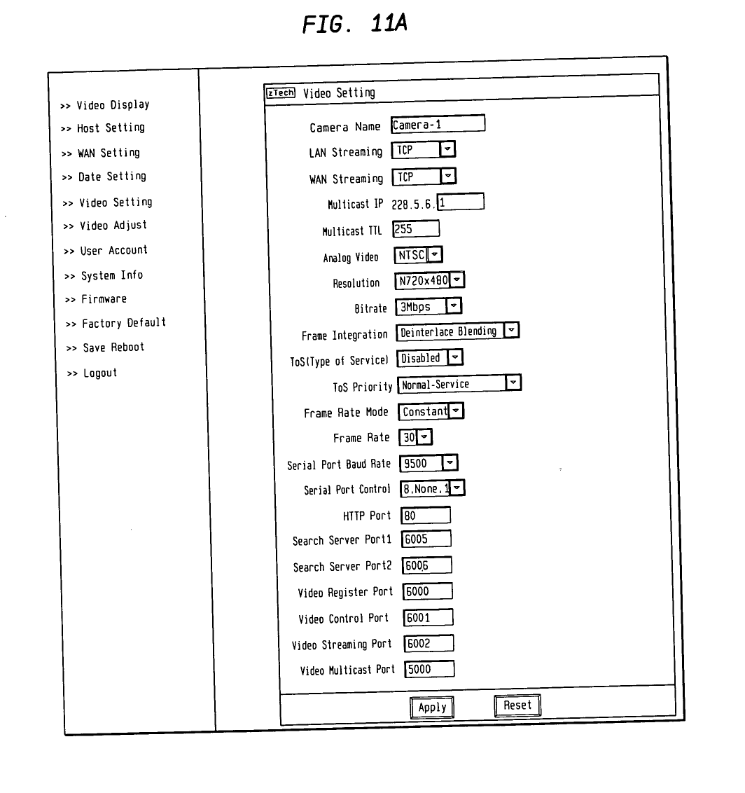

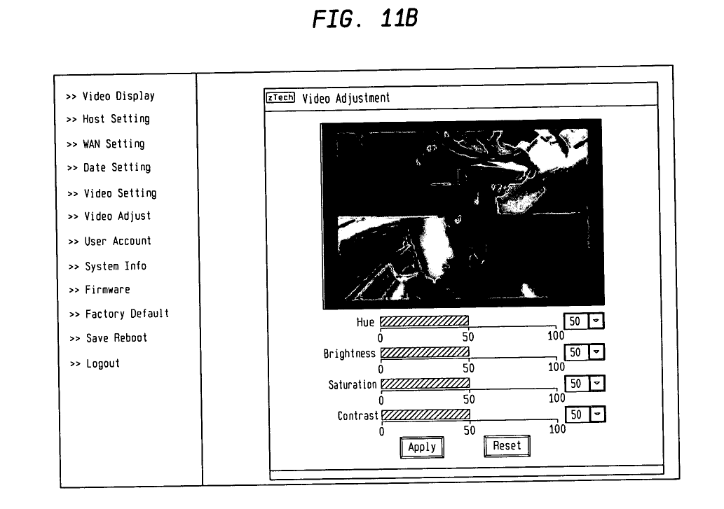

The network attributes page 154 may contain settings such as IP address, network sublayer information, encryption modes, listings of registered or active users, FTP information, network health data, etc. See, for instance, FIGS. 10A-10D, which illustrate several exemplary user interface pages that are preferably accessible via a web server. The camera attributes page 156 may contain general settings for camera/imager attributes such as login settings, day/night mode, I/O settings, storage locations for images, frame rate, image dewarping options, etc. See, for instance, FIG. 11A. The camera attributes page 156 may also include options for resolution selection, image formatting, contrast, color depth, etc. See, for instance, FIG. 11B, which presents options for adjusting hue, brightness, saturation and contrast. Image formatting may entail, by way of example only, manipulation of the size of the inner and/or outer rings radii for 360° panoramic images, aperture control, shutter speed, etc. The A/V attributes page 158 may contain settings for encoding depth, encoding type, compression ratio, multi- stream manipulation such as combining multiple image and/or audio feeds as a combined stream, etc.

The user interface 106 desirably provides a secure, password protected user link to the components within the network panoramic camera system 100. The user interface 106 (or multiple user interfaces) can be used by authorized personnel to provide, for example, real-time digitally encoded A/V information from the control subsystem 104, and/or to play back stored data from the control subsystem 104. As explained above, the user interface 106 is preferably a GUI. The GUI is preferably provided in accordance with a display and one or more input devices. In addition, a biometric input may also be included for access to the user interface 106. Components of a system to access the network panoramic camera system 100 will now be described.

The display may be any type of display capable of displaying text and/or images, such as an LCD display, plasma display or CRT monitor. While not required, it is preferable for the display to be able to output all of the image types transmitted by the control subsystem 104. Thus, in a preferred example, the display is a high resolution display capable of displaying JPEG images and MPEG-4 video. One or more speakers may be associated with the display to output audio received from the imaging subsystem 102 or from the sensory devices 108.

The input devices can be, by way of example only, a mouse and/or a keyboard; however, a touch screen, buttons, switches, knobs, dials, slide bars, etc may also be provided. Alternatively, at least some of the inputs may be implemented as “soft” inputs which may be programmable or automatically changed depending upon selections made by the user. For instance, the user interface 106 may require a user to input a password or other security identifier via the keyboard or via the biometric input. Prior to inputting the security identifier, a first soft input may be labeled as “ENTER AUTHORIZATION” and a second soft input may be labeled as “VERIFY”, and a third soft input may be labeled as “SECURITY MENU.” Once the user's security identifier is accepted, the first soft input may be relabeled as “CAMERA ATTRIBUTES,” the second input may be relabeled as “NETWORK ATTRIBUTES,” and the third input may be relabeled as “A/V ATTRIBUTES.”

The biometric input, if used, can provide a heightened level of security and access control. The biometric input may be, by way of example only, a fingerprint or hand scanner, a retinal scanner, a voice analyzer, etc. Alternatively, multiple biometric inputs can be used to assess multiple characteristics in combination, such as retinal and fingerprint scans, voice and fingerprint analysis, and so forth.

As a further option, the computer or other device accessing the user interface 106 may include a separate input to receive an authorization device such as a mechanical key, a magnetic swipe card, a radio frequency ID (“RFID”) chip, etc. Thus, it can be seen that there are many ways to provide security and limit access to the user interface 106 and the overall system 100. This can be a very important feature for many networks, for example those used for military or security applications. In such an environment, it may be essential to limit user interface access to selected users.

While only one user interface 106 is illustrated in the system of FIGS. 1 and 2, it should be understood that multiple user interfaces 106 may be deployed through web browsers across the network. Different users may be granted access to only some of the features of the user interface 106. For instance, some users may have access rights to the user interface 106 on a particular computing device; however, other users may have access rights to all user interfaces 106 on all computing devices in the network. In an alternative, some users may have full permission rights when using any of the user interfaces 106 to view, modify, and/or process audio/video and other data. In this case, other users may have restricted permission rights to some or all of the user interfaces 106, such as to view audio and video data only, and/or to send alarms. Still other users may have even more restricted access and/or permission rights, for instance limited to sending an alarm to a master user from a single computing device. Thus, it can be seen that access rights can include physical or logical access to the user interface 106, and permission rights can grant different levels of operational control to each user.

The network panoramic camera system 100 may be positioned at strategic locations as desired. For example, the network panoramic camera system 100 may be placed on a desktop or other piece of furniture. FIGS. 5(a) and 5(b) illustrate imaging subsystems 102 adapted for desktop and ceiling use, respectively. FIG. 5(c) illustrates a preferred embodiment of the network camera system 100 enclosed in a housing 160. The system in FIG. 5(c) is preferably fully integrated, including the imaging subsystem 102, the control subsystem 104, and the user interface 106 (see FIG. 1) as well as the external inputs shown in FIG. 7, which is described more fully below. The housing 160 may be placed anywhere desired, such as in an office, in a manufacturing facility, on a ship, on an airplane, etc. Furthermore, the housing 160 may be used indoors or outdoors. When used outdoors, additional coverings or materials may be used to protect the 360° lens system 112 and other components of the network camera system 100.

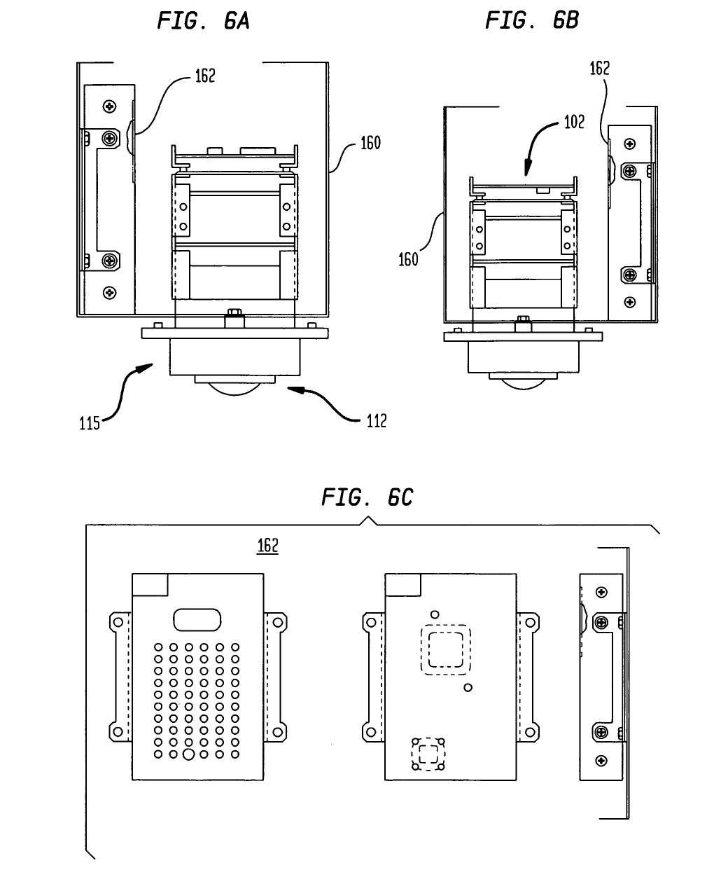

FIGS. 6(a) and 6(b) are side cutaway views of FIG. 5(c) illustrating the housing 160 and the modules contained therein. Here, at least some of the components of the imaging subsystem 102, the control subsystem 104 and the user interface 106 may be located in chassis 162. Desirably, the housing 160 contains a fully integrated network panoramic camera system 100. Preferably, all of the components of the imaging subsystem 102 are located in the housing 160 along with the control subsystem 104 and the user interface 106.

Specifically, the unit 115 and the rest of the imaging subsystem 102 are desirably positioned in one part of the housing 160, and the control subsystem 104, which performs A/D conversion, encoding, IP conversion, Power Over Ethernet, image storage and other functions explained above is located in the chassis 162. FIG. 6(c) illustrates a side view, an exterior elevation view and an interior elevation view of the chassis 162. The user interface 106 is also preferably located in the chassis 162, for instance as an application or an applet stored in memory of the control subsystem 104.

Thus, the fully integrated system is capable of producing analog 360° panoramic images, dewarping the images, generating digital image signals, encoding the digital image signals, and storing and/or transmitting the image signals to users on the network. The users access the fully integrated system via the user interface 106. Furthermore, the fully integrated system is desirably powered using Power Over Ethernet technology, which further enhances the robust features of the system.

Of course, it should be understood that many other configurations of the network panoramic camera system 100 are possible. For example, the imaging subsystem 102 may be located in a physically separate housing from the control subsystem 104 and/or the user interface 106. In this case, each of these elements may be connected to one another via wired and/or wireless links. Alternatively, any of the components from these elements may be located in the same housing along with any of the other components from the other elements. For instance, with reference to FIG. 2, the control subsystem 104, which preferably includes an MPEG4 encoder either as part of the controller or processor 136 or as part of another processor such as a DSP or ASIC, may be jointly housed along with the DSP 118 and the analog video coder 124 of the imaging subsystem 102 in one unit while the unit 115 may be located in a remote location in a physically separate housing.

FIG. 7 illustrates a section of the housing 160 showing external outputs from the imaging subsystem 102. For example, the housing 160 may include a power input 168 of, for example, 12 volts DC. The housing 160 may also include a LAN connection 170 and/or a WAN connection 172, which may be, for instance, Ethernet connections. In this case, when Power Over Ethernet is utilized, the power input 168 may be omitted, or may be disabled. Preferably, Power Over Ethernet is selected when power is sensed in the Ethernet connection and the power input 168 is accordingly disabled. Similarly, when the system detects that power is not present on the Ethernet connection, for instance when the CAT5 cable is unplugged, the power input 168 may then be enabled. This smart connect Power Over Ethernet scheme ensures robust operation of the system 100.

One or more I/O ports 174 may be utilized to receive commands and/or to output signaling information. Alternatively, the I/O ports 174 connect to external sensory devices 108. A connector 176 such as an RS-232 connector may also be utilized for command or signaling information or other data. By way of example only, the connector 176 can be used to send serial commands that change the view or perform other functions. The RS-232 connector 176 may be used in place of the remote control 128 discussed above. Preferably, the connector 176 enables two-way communication that permits input signals to select camera views or image views, for instance if the CAT5 cable is not working, or if the unit is operating in an analog mode, and also permits the output of signaling data such as motion detection coordinates, status of the system 100, I/O sensory information, etc. An A/V connection, such as connector 178, is preferably used to output data, which may be A/V data. By way of example only, the connector 178 may be a BNC or equivalent connector. The A/V data may be an analog NTSC signal used for a local spot monitor or when operating the camera in an analog mode. Here, inputs to the RS-232 connector may be used to change the views in the analog mode.

FIG. 8 illustrates a flow diagram 200, which shows an exemplary operational process of the network panoramic camera system 100. As shown at steps 202 and 204, the imaging subsystem 102 and the sensory device(s) 108 respectively generate data, either alone or in conjunction with one another. The data is provided to the control subsystem 104 and is processed at step 206 by, for instance, the A/D converter 134 and the processor or controller 136. By way of example only, A/V data from the imaging subsystem 102 and/or one of the sensory devices 108 is combined into a single A/V data stream and may be further processed using a facial recognition and/or a voice recognition application. Processed data is stored in a storage device such as the removable storage device 148 or the fixed storage device 146, as shown at step 208. A user of the user interface 106, which may be locally or remotely located on the network, may generate a request to, for instance, view A/V data or to cause the imaging subsystem 102 to perform a particular action. The control subsystem 104 may process the user request, as shown at step 210. Instructions or requests may be sent to the imaging subsystem 102 or the sensory devices 108 by the control subsystem 104, as shown at step 212. Of course, it should be understood that the control subsystem 104 may issue requests autonomously without user input. Data may be transmitted to other devices on the network as shown at step 214. Here, the control subsystem 104 may also receive instructions or requests from other users or devices on the network. The network panoramic camera system 100 may then continue with its operations as shown at step 216, for example with the control subsystem 104 returning to processing data as in step 206.

FIG. 9 illustrates a flow diagram 300, which shows an exemplary operational process 300 of the user interface 106. Here, a user may log in and the web server, through the user interface 106, may verify his or her access, as shown at step 302. The web server/user interface 106 may perform the verification locally or may interact with the control subsystem 104 or other device(s) on the network. In this case, the web server/user interface 106 may transmit the user's passcode and/or biometric data to the control subsystem 104 or the networked device, which may issue compare the information against information in a database stored, e.g., in the fixed storage device 146 or the removable storage device 148. The control subsystem 104 may then issue final approval of the user to the web server/user interface 106.

Once the user has been authenticated, he or she may request data from the system, as shown at step 304. For instance, the user may request current imaging data from the control subsystem 104 or an original analog feed from the imaging subsystem 102. The user may also request current sensory data directly from the sensory device(s) 108. The user may also request stored or processed imaging or sensory data from the control subsystem 104. Assuming that the user has the appropriate level of permission rights, the requested information is displayed or otherwise presented at step 306. At step 308 the user may also send some or all of this data to another user or to another networked device, to the control subsystem 104 for additional processing, etc. Then at step 610 the process may return to step 304 so the user may request additional data to view. While the exemplary flow diagrams of FIGS. 8 and 9 illustrate steps in a certain order, it should be understood that different steps may be performed in different orders, and certain steps may be omitted.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. By way of example only, while different embodiments described above illustrate specific features, it is within the scope of the present invention to combine or interchange different features among the various embodiments to create other variants. Any of the features in any of the embodiments can be combined or interchanged with any other features in any of the other embodiments. Furthermore, in addition to a preferred embodiment of the invention that streams the encoded A/V digital data across a network such as an IP-based network, the system may also be used in any number of other systems, such as a closed circuit television system. Optionally, the 360° imaging subsystem 102 may be interconnected with conventional non-panoramic cameras, through, for example, I/O connectors 174 and/or connector 178. In this case, the control subsystem 104 may integrate and process the A/V data from different imaging systems/cameras either as a single data stream or as separate data streams, which may be stored, processed, and distributed across the network as described herein. The video analyzer may be part of the microprocessor 136 or a separate device, and may used with any of the other components described herein. For instance, the video analyzer may operation with the imaging subsystem and/or the control subsystem to provide automated operation of the overall system. The video analyzer may also be operatively coupled with the user interface. Thus, an authorized user may receive information from the user interface based on information generated with control data from the video analyzer. The user interface may also provide control information to the video analyzer.

1. A panoramic camera system for use in processing full panoramic images, the system comprising:
a panoramic imaging subsystem operable to capture a full panoramic image and to create panoramic image data therefrom;
a control subsystem operable to generate digital data from the panoramic image data, the control subsystem including:
a processor operable to receive the panoramic image data and to create processed digital image data therefrom, and
a digital encoder in operative communication with the processor for generating encoded visual data; and
a web-server based user interface in operative communication with the panoramic imaging subsystem and the control subsystem, the user interface being operable to receive commands from an authorized user, to direct operation of the panoramic imaging subsystem and the control subsystem based on the received commands, and to display the digital data to the authorized user in a predetermined format.

2. The system of claim 1, further comprising:
a sensory device in operative communication with the control subsystem and the user interface, the sensory device being operable to sense a condition associated with the panoramic camera system;
wherein the processor is further operable to process input sensory data from the sensory device and incorporate the processed sensory data with the processed digital imaging data to generate the digital data therefrom.

3. The system of claim 2, wherein the user interface is further operatively connected to the sensory device, the user interface enabling the authorized user to select imaging parameters to manage operation of the panoramic imaging subsystem, to select control parameters to manage operation of the control subsystem, and to select sensory parameters to manage operation of the sensory device.

4. The system of claim 3, wherein the user interface is further operable to select one or more view types based upon the panoramic imaging data to present displayed data to the authorized user in the predetermined format.

5. The system of claim 4, wherein the view types include at least one of ring, wide, half wide, dual half wide, dual half wide mirror, quad, quad and wide, quad and zoom, and wide and zoom.

6. The system of claim 2, wherein the control subsystem generates processed digital data by digitizing, packetizing and streaming the panoramic imaging data and the sensory data together.

7. The system of claim 1, wherein the predetermined format does not require processing in order to display the display data.

8. The system of claim 1, wherein the panoramic imaging subsystem includes a plurality of full panoramic imaging devices, and the control subsystem is operable to receive and process the panoramic imaging data from each imaging device together.

9. The system of claim 8, wherein each of the imaging devices is managed by the user interface.

10. The system of claim 9, wherein if the system senses an environmental condition associated with the system, at least one of the imaging devices generates selected imaging data in response thereto.

12. The system of claim 11, wherein selected parameters of each of the imaging devices are controlled independently through the user interface.

13. The system of claim 1, wherein the control subsystem further comprises a networking subsystem operable to provide data communication with and a power supply to the panoramic imaging subsystem.

14. The system of claim 13, wherein the networking subsystem provides an Ethernet connection to the panoramic imaging subsystem for the data communication, and power is supplied over the Ethernet connection.

15. The system of claim 2, further comprising a video analyzer operatively connected to the panoramic imaging subsystem and the control subsystem, the video analyzer being operable to analyze the digital data to identify at least one of a visual characteristic and a sensory characteristic, and to direct at least one of the panoramic imaging subsystem and the control subsystem to utilize a selected parameter in response to at least one of the visual and the sensory characteristic.

16. A panoramic image processing method, comprising:
generating full panoramic imaging data with a full panoramic imager;
creating panoramic image data from the full panoramic imaging data;
generating sensory device data based upon an environmental condition;
processing the panoramic image data and the sensory device data; and
generating display data based upon the processed panoramic image data and sensory device data.

17. The method of claim 16, further comprising:
authenticating a user; and
presenting the display data to the user after authentication.

18. The method of claim 16, wherein the panoramic imaging data is integrated with the sensory data during processing, and the integrated data is packetized according to a predetermined format.

19. The method of claim 18, wherein the sensory data is audio data associated with the full panoramic imaging data.

20. The method of claim 16, further comprising powering the full panoramic imager over an Ethernet connection.

21. The method of claim 16, wherein if the environmental condition is an alarm condition, the panoramic image data is created according to a pre-selected format.

22. The method of claim 16, further comprising:
analyzing the processed panoramic image data and the sensory device data to identify at least one of a visual characteristic and a sensory characteristic; and
utilizing a selected parameter in response to the visual or sensory characteristic to vary at least one of the panoramic image data and the sensory device data.

23. A panoramic image processing apparatus, comprising:
means for receiving panoramic imaging data from a full panoramic imaging device;
means for processing the received panoramic imaging data to create processed digital imaging data therefrom;
means for encoding the processed digital imaging data;
means for presenting the encoded and processed digital imaging data to a user of the apparatus; and
user interface means for receiving user input and for controlling operation of the processing means, the encoding means and the presenting means.

24. The apparatus of claim 23, wherein the processing means is operable to receive sensory data from a sensory device and to process the panoramic imaging data and the sensory data together.

25. The apparatus of claim 24, wherein processing the panoramic imaging data and the sensory data together includes digitizing and packetizing the panoramic imaging data and the sensory data.

26. The apparatus of claim 23, wherein the means for receiving panoramic imaging data is operable to receive the panoramic imaging data from a plurality of networked imaging devices, the apparatus further comprising means for receiving sensory data from a plurality of networked sensory devices, the processing means is further operable to multiplex the panoramic imaging data and the sensory data together, and the presenting means is further operable to generate display data for presentation to the user in a predetermined format including at least some of the multiplexed panoramic imaging data and the sensory data.

27. The apparatus of claim 26, further comprising a video analyzer operable to analyze the multiplexed panoramic imaging data and the sensory data to identify at least one of a visual characteristic and a sensory characteristic, and to direct at least one of capture and processing of the panoramic imaging data in response to the identified characteristic.
